(19) United States
(12) Patent Application Publication
(10) Pub. No.: US 2021/0341924 A1
(43) Pub. Date: Nov. 4, 2021

(54) PHOTOGRAPHY CONTROL METHOD AND MOBILE PLATFORM

(71) Applicant: SZ DJI TECHNOLOGY CO., LTD., Shenzhen (CN)

(72) Inventors: Chao WENG, Shenzhen (CN); Li QIU, Shenzhen (CN); Qi ZHOU, Shenzhen (CN)

(21) Appl. No.: 17/375,616

(22) Filed: Jul. 14, 2021

Related U.S. Application Data
(63) Continuation of application No. PCT/CN2019/072231, filed on Jan. 17, 2019.

(51) Int. Cl. G05D 1/00; H04N 5/232; B64C 39/02

(52) U.S. Cl. CPC G05D 1/0094; H04N 5/23222; B64C 2201/127; B64C 39/024; B64C 2201/123; H04N 5/23216

(57) ABSTRACT

A photography control method includes controlling a mobile platform to move, when the mobile platform is at a predetermined photography point, obtaining a pre-stored sample image of the predetermined photography point, and adjusting, according to a real-time photography picture captured by a camera device of the mobile platform and the sample image, a control parameter of the camera device to cause the camera device to photograph a target object.

### CROSS-REFERENCE TO RELATED APPLICATION

This application is a continuation of International Application No. PCT/CN2019/072231, filed Jan. 17, 2019, the entire content of which is incorporated herein by reference.

### TECHNICAL FIELD

The present disclosure generally relates to the photographing field and, more particularly, to a photography control method and a mobile platform.

### BACKGROUND

In some fields such as inspection, a mobile platform is configured to perform a photographing task. Usually, the mobile platform needs to keep a certain safety distance from a target object. A camera device on the mobile platform may photograph with a long focal length. When the mobile platform repeats flight for operation, due to a small field of view and errors of a position and attitude of the mobile platform, a repetition accuracy of images obtained by the camera device photographing repeatedly at a same photographing position cannot be ensured. The target object may not be in the images or off an expected position of the images. Thus, the repeatability of collecting the images is poor.

### SUMMARY

Embodiments of the present disclosure provide a photography control method. The method includes controlling a mobile platform to move, when the mobile platform is at a predetermined photography point, obtaining a pre-stored sample image of the predetermined photography point, and adjusting, according to a real-time photography picture captured by a camera device of the mobile platform and the sample image, a control parameter of the camera device to cause the camera device to photograph a target object.

Embodiments of the present disclosure provide a mobile platform including a platform body, a camera device, and a controller. The camera device is carried by the platform body. The controller is electrically coupled to the camera device and configured to control a mobile platform to move, when the mobile platform is at a predetermined photography point, obtain a pre-stored sample image of the predetermined photography point, and adjust, according to a real-time photography picture of a camera device of the mobile platform and the sample image, a control parameter of the camera device to cause the camera device to photograph a target object.

### BRIEF DESCRIPTION OF THE DRAWINGS

FIG. 1 is a schematic flowchart of a photography control method according to some embodiments of the present disclosure.

FIG. 2A is a schematic flowchart of a photography control method according to some embodiments of the present disclosure.

FIG. 2B is a schematic diagram showing an application scene for comparing a real-time photographed picture with a sample image in the photography control method shown in FIG. 2A.

FIG. 2C is a schematic diagram showing another application scene for comparing a real-time photographed picture with a sample image in the photography control method shown in FIG. 2A.

FIG. 3A is a schematic flowchart of another photography control method according to some embodiments of the present disclosure.

FIG. 3B is a schematic diagram showing an application scene for comparing a real-time photographed picture with a sample image in the photography control method shown in FIG. 3A.

FIG. 3C is a schematic diagram showing another application scene for comparing a real-time photographed picture with a sample image in the photography control method shown in FIG. 3A.

FIG. 4 is a schematic structural diagram of a mobile platform according to some embodiments of the present disclosure.

FIG. 5 is a schematic structural block diagram of a mobile platform according to some embodiments of the present disclosure.

### DETAILED DESCRIPTION OF THE EMBODIMENTS

The technical solution of embodiments of the present disclosure is described in detail in connection with the accompanying drawings of embodiments of the present disclosure. Described embodiments are merely some embodiments, not all embodiments. Based on embodiments of the present disclosure, all other embodiments obtained by those of ordinary skill in the art without creative efforts are within the scope of the present disclosure.

A mobile platform of embodiments of the present disclosure may include a platform body and a camera device carried by the platform body. The mobile platform may include an unmanned aerial vehicle, another unmanned aircraft, or another mobile apparatus.

In connection with the accompanying drawings, a photography control method and the mobile platform of the present disclosure are described in detail. When there is no conflict, embodiments and features of embodiments may be combined with each other.

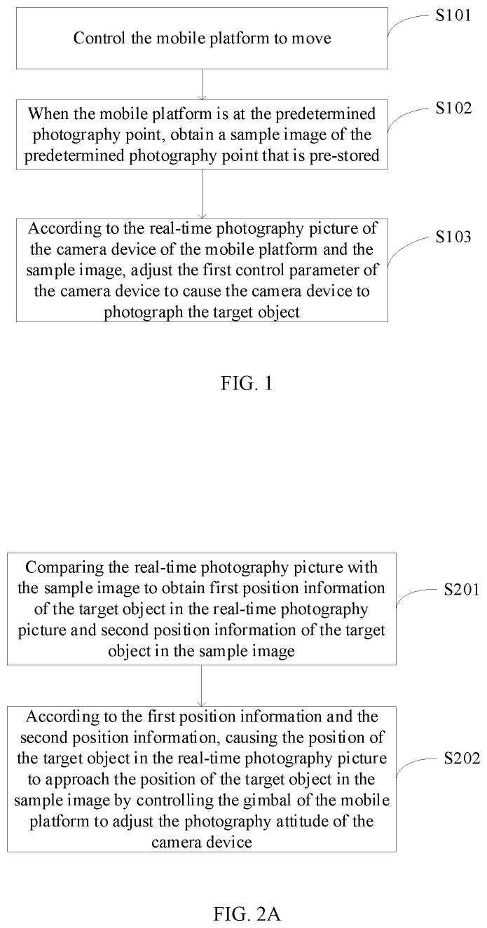

FIG. 1 is a schematic flowchart of the photography control method according to some embodiments of the present disclosure. As shown in FIG. 1, the photography control method includes the following processes.

At S101, the mobile platform is controlled to move.

In some embodiments, the platform may be controlled by a user to move. Process S101 may include receiving a user instruction transmitted by a ground end apparatus and controlling the mobile platform to fly according to the user instruction. The ground end apparatus may include a remote controller, a terminal (e.g., a mobile terminal or a fixed terminal) for controlling the mobile platform, a smart wearable apparatus, or another apparatus. In some embodiments, before the mobile platform executes process S101, one or more predetermined photography points may need to be determined.

In some other embodiments, the mobile platform may fly autonomously. Process S101 may include controlling the mobile platform to fly according to the predetermined flight path information. The predetermined flight path information may include position information of at least one flight point. Further, the predetermined flight path information may include position information of the mobile platform at predetermined photography points and a second control parameter of the mobile platform at the predetermined photography points. The predetermined photography points may include at least a part of the flight points, or the predetermined photography points may be different from the flight points. In embodiments of the present disclosure, inspection operation may be performed in an automatic process not in a manual flight, which may save manpower and improve the efficiency of the inspection operation. In some embodiments, the mobile platform may pre-store the predetermined flight path information. After receiving a movement trigger signal, the mobile platform may call the predetermined flight path information and control the mobile platform to fly according to the predetermined flight path information. The movement trigger signal may include a turn-on signal, a start signal generated when the user operates a start button of the mobile platform or a start signal transmitted by the user through the ground end apparatus. In some embodiments, before executing process S101, the mobile platform may need to determine the predetermined flight path information.

In some embodiments, determining the predetermined photography point may include receiving a user instruction transmitted by the ground end apparatus, controlling the mobile platform to fly according to the user instruction, in the flight of the mobile platform, if a photography point determination instruction transmitted by the ground end apparatus is received, determining a current position of the mobile platform as a predetermined photography point, and obtaining and saving the position information of the predetermined photography point. In some embodiments, the user may directly enter the position information of the predetermined photography point through an application (APP). The APP may transmit the position information of the predetermined photography point to the mobile platform. The mobile platform may receive and save the position information of the predetermined photography point.

The predetermined flight path information may be determined by the user controlling the mobile platform to move or set by the user in the APP.

The second control parameter may include at least one of an attitude of the mobile platform, a photography attitude of the camera device, or a photography parameter of the camera device. the second control parameter may not be limited to the above-listed parameters and may include another parameter of the mobile platform. In some embodiments, obtaining the second control parameter may include receiving the user instruction transmitted by the ground end apparatus, controlling the mobile platform to fly according to the user instruction, in the flight of the mobile platform, if the photography point determination instruction transmitted by the ground end apparatus is received, obtaining the attitude of the mobile platform, the photography attitude of the camera device, and/or the photography parameter of the camera device at the current position, and using the attitude of the mobile platform, the photography attitude of the camera device, and/or the photography parameter of the camera device at the current position as the second control parameter of the mobile platform at the predetermined photography point.

In some embodiments, after receiving the photography point determination instruction transmitted by the ground end apparatus, and before obtaining the attitude of the mobile platform, the photography attitude of the camera device, and/or the photography parameter of the camera device at the current position, determining the second control parameter may further include receiving an adjustment parameter transmitted by the ground end apparatus, adjusting an attitude of the mobile platform, a photography attitude of the camera device, and/or a photography parameter of the camera device according to the adjustment parameter, and replacing the attitude of the mobile platform, the photography attitude of the camera device, and/or the photography parameter of the camera device at the current position by the attitude of the mobile platform, the photography attitude of the camera device, and/or the photography parameter of the camera device after the parameter is adjusted.

For example, after receiving the photography point determination instruction transmitted by the ground end apparatus, and before obtaining the attitude of the mobile platform, the photography attitude of the camera device, and/or the photography parameter of the camera device at the current position, if the adjustment parameter transmitted by the ground end apparatus is received, according to the adjustment parameter, only the attitude of the mobile platform may be adjusted. At the current position, the attitude of the mobile platform may be replaced by the attitude of the mobile platform after the parameter is adjusted. At the current position, the photography attitude of the camera device and/or the photography parameter of the camera device may be still the photography attitude of the camera device and/or the photography parameter of the camera device when the mobile platform received the photography point determination instruction transmitted by the ground end apparatus.

In some embodiments, according to the predetermined flight path information, controlling the mobile platform to fly may further include when the mobile platform is at the predetermined photography point, controlling a real-time attitude of the mobile platform, a real-time photography attitude of the camera device and/or a real-time parameter of the camera device according to the second control parameter. Each time when the mobile platform reaches the predetermined photography point, controlling the real-time attitude of the mobile platform, the real-time photography attitude of the camera device, and/or the real-time photography parameter of the camera device according to the second control parameter to be nearly the same to ensure the camera device to meet the photography requirements each time at the predetermined photography point.

At S102, when the mobile platform is at the predetermined photography point, a sample image of the predetermined photography point that is pre-stored is obtained.

In process S102, a process of determining the predetermined photography point is similar to a process of determining the predetermined photography point in process S101, which is not repeated here.

Pre-storing the sample image of the predetermined photography point may include receiving the user instruction transmitted by the ground end apparatus, controlling the mobile platform to fly according to the user instruction, in the flight of the mobile platform, if the photography point determination instruction transmitted by the ground end apparatus is received, determining the current position of the mobile platform as the predetermined photography point, controlling the camera device of the mobile platform to obtain the sample image with a predetermined configuration at the predetermined photography point, obtaining the position information of the predetermined photography point, and saving the position information of the predetermined photography point and the sample image at the predetermined photography point. In some embodiments, the predetermined configuration may include that the target object may be at a predetermined position of the photography picture of the camera device, such as a center of the photography picture or another position. In some embodiments, the predetermined configuration may include that a size of the target object in the photography picture of the camera device may include a predetermined size, such as in an image with a resolution of 640×480, the size of the target object in the photography picture of the camera device may be 320×240.

In some embodiments, the position information and the sample image of the predetermined photography point may be saved in a one-to-one correspondence. For example, the position information of the predetermined photography point 1 and the sample image of the predetermined photography point 1 may be saved in a database or another predetermined APP in a one-to-one correspondence.

In some embodiments, saving the position information of the predetermined photography point and the sample image of the predetermined photography point may include saving the position information of the predetermined photography point at the mobile platform or the ground end apparatus and saving the sample image at the camera device or the ground end apparatus. In some embodiments, by saving the position information of the predetermined photography point at the mobile platform or the ground end apparatus, the mobile platform may obtain the position information of the predetermined photography point conveniently. Then, the mobile platform may control the mobile platform to collect the image of the target object at the predetermined photography point. The mobile platform may also save the sample image at the camera device or the ground end apparatus. The real-time photography picture may be compared with the sample image by the camera device or the ground end apparatus. Then, a first control parameter of the camera device may be adjusted by the mobile platform according to a comparison result to cause the camera device to photograph the target object. In some embodiments, the comparison process may be performed at the camera device or the ground end apparatus to reduce the burden of the data processing of the mobile platform. In some embodiments, the sample image may be saved in a secure digital (SD) card of the camera device. During the operation of the mobile platform, each time the mobile platform flies to the predetermined photography point, the camera device may compare the real-time photography picture and the image data in the SD card. Then, the gimbal may be slightly adjusted to a position with a field of view same as the predetermined photography point when the sample image is collected according to the comparison result to ensure repeatability of collecting the image.

Further, in some embodiments, the resolution of the sampled image may not need to be too large. The mobile platform may only need to determine an image parameter such as a position and/or a size of the target object in the sampled image. Therefore, before saving the sample image at the camera device or the ground end apparatus, the mobile platform may perform the following sampling process on the sample image. The mobile platform of embodiments of the present disclosure may save the sample image after the sampling process at the camera device or the ground end apparatus to reduce a storage data amount. In some embodiments, the sample image of each predetermined photography point may be downsampled to a video graphics array (VGA) or another image type with a small resolution.

In the inspection field, the camera device of the mobile platform may need to photograph the target object away from the target object with a certain safety distance (e.g., 20 m). In some embodiments, no matter during determining the predetermined photography point, determining the predetermined flight path information, pre-storing the sample image of the predetermined photography point, or the actual inspection, according to the user instruction, controlling the mobile platform to fly may include controlling a real-time height between the lens of the camera device and the target object to be greater than or equal to a predetermined height threshold. The predetermined height threshold may include 20 m or another value.

At S103, according to the real-time photography picture of the camera device of the mobile platform and the sample image, the first control parameter of the camera device is adjusted to cause the camera device to photograph the target object.

In some embodiments, adjusting the first control parameter of the camera device to cause the camera device to photograph the target object may include adjusting the first control parameter of the camera device to cause the image parameter of the target object in the real-time photography picture to approach the image parameter of the target object in the sample image to ensure the repetitive precision each time the mobile platform collects the image at the predetermined photography point. The image parameter of the target object in the real-time photography picture may include the position and/or size of the target object in the real-time photography picture. In some embodiments, the mobile platform may need to adjust the first control parameter of the camera device to cause the position of the target object in the real-time photography picture to approach the position of the target object in the sample image. In some embodiments, the mobile platform may need to adjust the first control parameter of the camera device to cause the size of the target object in the real-time photography picture to approach the size of the target object in the sample image. In some embodiments, the target object may in the center of the sample image, and the size of the target object in the sample image may be 320×240. The mobile platform of embodiments of the present disclosure may need to adjust the first control parameter of the camera device to cause the target object to be in the center of the real-time photography picture and the size of the target object in the real-time photography picture to be 320×240.

The first control parameter may include the photography attitude of the camera device and/or the photography parameter of the camera device. the first control parameter may not be limited to this and may include another control parameter of the camera device.

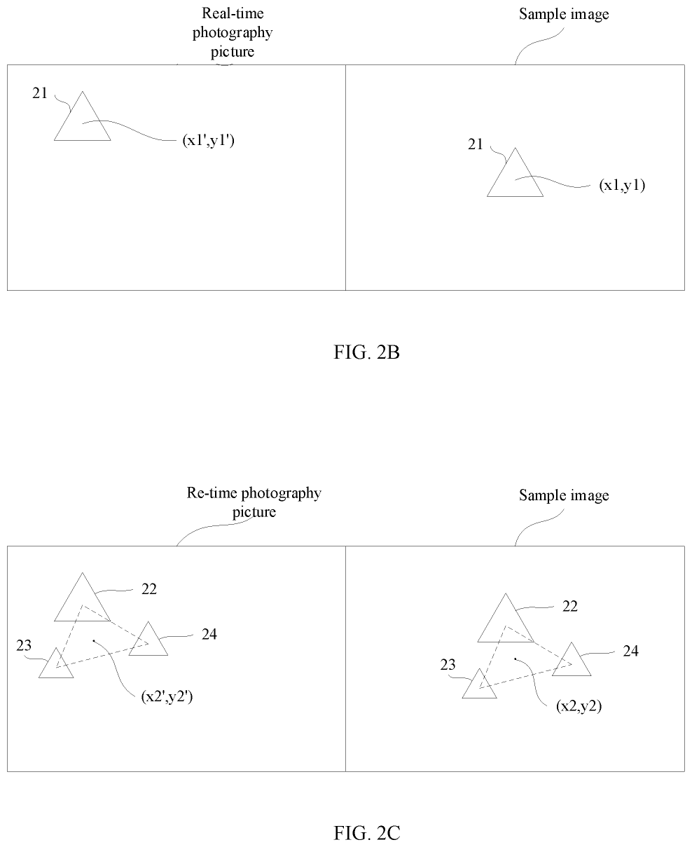

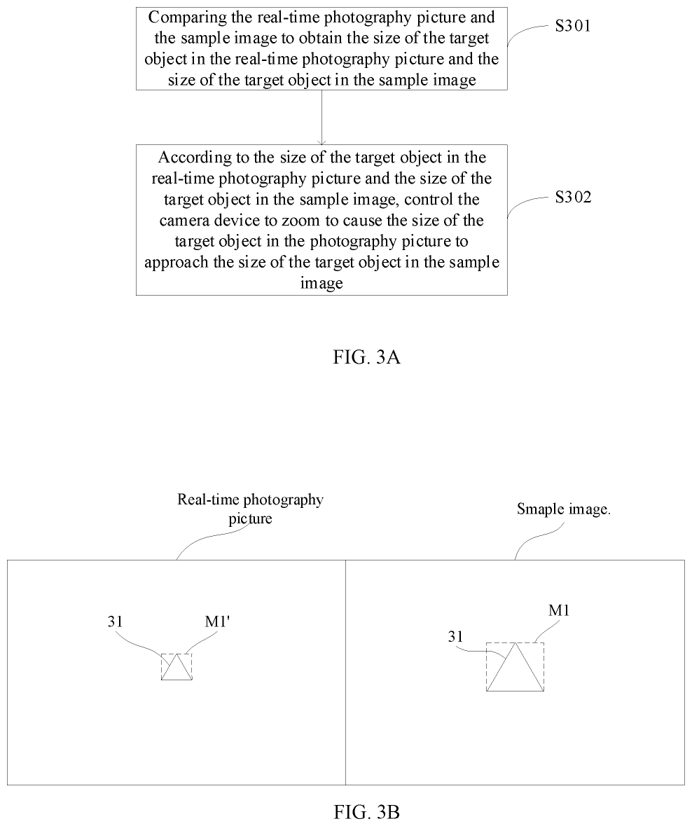

According to embodiments corresponding to FIG. 2A and FIG. 3A, in process S103, according to the real-time photography picture of the camera device and the sample image, adjusting the first control parameter of the camera device is described in detail below. In some embodiments, as shown in FIG. 2A, process S103 may be replaced by processes S201 and S202. In some embodiments, as shown in FIG. 3A, process S103 may be replaced by processes S301 and S302.

In some embodiments, as shown in FIG. 2A, after comparing the real-time photography picture and the sample image, according to the position of the target object in the real-time photography picture and the position of the target object in the sample image, the mobile platform may adjust the attitude of the camera device to cause the position of the target object in the real-time photography picture to approach the position of the target object in the sample image. In some embodiments, the camera device may be carried by the platform body of the mobile platform through the gimbal to stabilize the camera device. In some embodiments, the gimbal may include a dual-axis gimbal or a three-axis gimbal.

FIG. 2A is a schematic flowchart of a photography control method according to some embodiments of the present disclosure. As shown in FIG. 2A, according to the real-time photography picture of the camera device and the sample image, the mobile platform adjusting the first control parameter of the camera device includes comparing the real-time photography picture with the sample image to obtain first position information of the target object in the real-time photography picture and second position information of the target object in the sample image (S201) and, according to the first position information and the second position information, causing the position of the target object in the real-time photography picture to approach the position of the target object in the sample image by controlling the gimbal of the mobile platform to adjust the photography attitude of the camera device (S202).

In some embodiments, according to the first position information and the second position information, adjusting the photography attitude of the camera device may include according to the first position information and the second position information, determining a position deviation, and according to the position deviation, adjusting the photography attitude of the camera device by controlling the attitude of the gimbal. In some embodiments, according to the position deviation, the attitude of the gimbal may be controlled to cause the position of the target object in the real-time photography picture to be same as the position of the target object in the sample image. In some embodiments, according to the position deviation, the attitude of the gimbal may be controlled to cause the position of the target object in the real-time photography picture to be nearly same as the position of the target object in the sample image.

In some embodiments, one target object may be included. As shown in FIG. 2B, the target object includes a target object 21. The first position information includes that a gravity center of the target object 21 is at (x1′, y1′) in the real-time photography picture. The second position information includes that a gravity center of the target object 21 is at (x1, y1) in the sample image. Assume that a width and a height of the real-time photography picture may be equal to a width and a height of the sample image. The mobile platform may need to move the gravity center of the target object 21 from (x1′, y1′) in the real-time photography picture to (x1, y1). In some embodiments, by adjusting a yaw attitude of the gimbal, a horizontal coordinate x1′ of the gravity center of the target object 21 in the real-time photography picture may be adjusted to x1. By adjusting the pitch attitude of the gimbal, a vertical coordinate y1′ of the gravity center of the target object 21 in the real-time photography picture may be adjusted to y1.

In some other embodiments, a plurality of target objects may be included. As shown in FIG. 2C, the plurality of target objects include a target object 22, a target object 23, and a target object 24. The first position information includes that gravity centers the three target objects of the target object 22, the target object 23, and the target object 24 are at (x2′, y2′) in the real-time photography picture. The second position information includes that gravity centers of the three target objects of the target object 22, the target object 23, and the target object 24 are at (x2, y2) in the sample image. Assume that the width and the height of the real-time photography picture may be equal to the width and the height of the sample image. The mobile platform may need to move the gravity centers of the three target objects of the target object 22, the target object 23, and the target object 24 from (x2′, y2′) in the real-time photography picture to (x2, y2). In some embodiments, by adjusting the yaw attitude of the gimbal, a horizontal coordinate x2′ of the gravity centers of the three target objects of the target object 22, the target object 23, and the target object 24 in the real-time photography picture may be adjusted to x2. By adjusting the pitch attitude of the gimbal, a vertical coordinate y2′ of the gravity center of the three target objects of the target object 22, the target object 23, and the target object 24 in the real-time photography picture may be adjusted to y2.

In some embodiments shown in FIG. 3A, after comparing the real-time photography picture with the sample image, according to the size of the target object in the real-time photography picture and the size of the target object in the sample image, the mobile platform adjusts the camera device to zoom to cause the size of the target object in the real-time photography picture to approach to the size of the target object in the sample image.

FIG. 3A is a schematic flowchart of another photography control method according to some embodiments of the present disclosure. As shown in FIG. 3A, according to the real-time photography picture of the camera device and the sample image, the mobile platform adjusting the first control parameter of the camera device includes comparing the real-time photography picture and the sample image to obtain the size of the target object in the real-time photography picture and the size of the target object in the sample image (S301) and according to the size of the target object in the real-time photography picture and the size of the target object in the sample image, controlling the camera device to zoom to cause the size of the target object in the photography picture to approach the size of the target object in the sample image (S302).

In some embodiments, according to the size of the target object in the real-time photography picture and the size of the target object in the sample image, controlling the camera device to zoom may include the size of the target object in the real-time photography picture and the size of the target object in the sample image, determining a zoom parameter of the camera device and controlling the camera device to zoom according to the zoom parameter. In some embodiments, the zoom parameter may be equal to the size of the target object in the sample image/the size of the target object in the real-time photography picture. In some embodiments, the size of the target object in the real-time photography picture may include a size of a target frame enclosed by the width and height of the target object in the real-time photography picture. The target frame may entirely enclose the target object. In some embodiments, according to the zoom parameter, the camera device may be controlled to zoom to cause the size of the target object in the real-time photography picture to be equal to the size of the target object in the sample image. In some embodiments, according to the zoom parameter, the camera device may be controlled to zoom to cause the size of the target object in the real-time photography image to be nearly equal to the size of the target object in the sample image.

In some embodiments, one target object may be included. As shown in FIG. 3B, the target object includes a target object 31. A size of the target object 31 in the real-time photography picture may be a size (i.e., width and height) of a target frame M1′. The size of the target object 31 in the sample image may be a size of a target frame M1. The zoom parameter may be equal to the size of the target frame M1/the size of the target frame M1′. According to the zoom parameter, the mobile platform may control the camera device to zoom to cause the size of the target object in the photography picture to approach the size of the target object in the sample image.

In some other embodiments, a plurality of target objects may be included. As shown in FIG. 3C, the plurality of target objects include a target object 32, a target object 33, and a target object 34. Sizes of the target object 32, the target object 33, and the target object 34 in the real-time photography picture may include a size (i.e., width and height) of the target frame M2′. Sizes of the target object 32, the target object 33, and the target object 34 in the sample image may include a size of the target frame M2. The zoom parameter may be equal to the size of the target frame M2/the size of the target frame M2′. According to the zoom parameter, the mobile platform may control the camera device to zoom to cause the size of the target object in the photography picture to approach the size of the target object in the sample image.

In some embodiment, the sample image of the predetermined photography point may be saved in the camera device. An execution body for comparing the real-time photography picture with the sample image may include the camera device. In some other embodiments, the sample image of the predetermined photography point may be saved in the ground end apparatus. The execution body for comparing the real-time photography picture with the sample image may include the ground end apparatus. By performing the comparison process in the camera device or the ground end apparatus, the burden of the data processing of the mobile platform may be reduced.

In addition, according to the real-time photography picture and the sample image, after adjusting the first control parameter of the camera device to the camera device to photograph the target object, the mobile platform may need to save the image captured by the camera device at the predetermined photography point to realize automatic inspection.

In some embodiments, processes S102 and S103 may be performed when the mobile platform is in a hovering state, which may reduce a control requirement for the mobile platform.

In the photography control method of embodiments of the present disclosure, during the operation process of the mobile platform, when the mobile platform is located at the predetermined photography point, the camera device may be adjusted through the real-time photography picture of the camera device and the sample image of the predetermined photography point that is pre-stored, and the repetitive precision of the image collection during the repetitive flight operation may be ensured through the image comparison function.

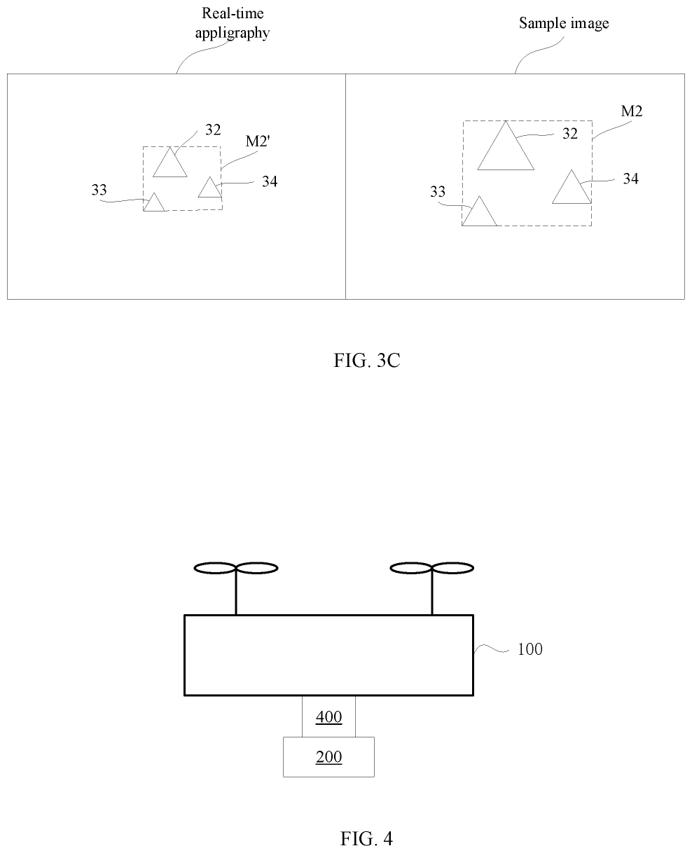

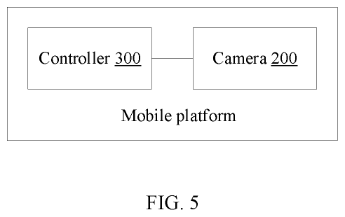

Corresponding to the photography control method of embodiments of the present disclosure, embodiments of the present disclosure may further provide a mobile platform. In connection with FIG. 4 and FIG. 5, the mobile platform includes a platform body, a camera device carried at the platform body, and a controller. The controller may be electrically coupled to the camera device.

The controller of embodiments of the present disclosure is configured to perform the photography control method of embodiments shown in FIG. 1, FIG. 2A, and FIG. 3A.

In some embodiments, the controller may be configured to control the mobile platform to move, when the mobile platform is at the predetermined photography point, obtain the pre-stored sample image of the predetermined photography point, according to the real-time photography picture of the camera device of the mobile platform and the sample image, adjust the first control parameter of the camera device to cause the camera device to photograph the target object.

In some embodiments, the controller may include a central processing unit (CPU). The controller may further include a hardware chip. The hardware chip may include an application-specific integrated circuit (ASIC), a programmable logic device (PLD), or a combination thereof. The PLD may include a complex programmable logic device (CPLD), a field-programmable gate array (FPGA), a generic array logic (GAL), or a combination thereof.

Further, with reference to FIG. 4, the mobile platform of embodiments of the present disclosure further includes a gimbal. The camera device is fixed at the platform body through the gimbal. In some embodiments, the camera device may directly be electrically coupled to the controller. In some embodiments, the camera device may be electrically coupled to the controller through the gimbal.

In some embodiments, when the mobile platform includes a UAV, the platform body may include the vehicle body of the UAV. The UAV may include a multi-rotor UAV or a fixed-wing UAV.

In addition, embodiments of the present disclosure further provide a computer-readable storage medium. The computer-readable storage may store a computer program that, when executed by the processor, causes the processor to realize the processes of the photography control method of embodiments of the present disclosure.

Those of ordinary skill in the art may understand that all or a part of processes for realizing method embodiments of the present disclosure may be completed by the computer program instructing related hardware. The program may be stored in the computer-readable storage medium that, when executed, causes the processor to perform the processes of method embodiments. The computer-readable storage medium may include a magnetic disc, an optical disc, a random access memory (RAM), or a read-only memory (ROM).

Some embodiments of the present disclosure are disclosed above, which cannot be used to limit the scope of the present disclosure. Equivalent modifications made according to the claims of the present invention are still within the scope of the present invention.

What is claimed is:

1. A photography control method comprising:
controlling a mobile platform to move;
in response to the mobile platform being at a predetermined photography point, obtaining a pre-stored sample image of the predetermined photography point; and
adjusting, according to a real-time photography picture captured by a camera device of the mobile platform and the sample image, a control parameter of the camera device to cause the camera device to photograph a target object.

2. The method of claim 1, wherein adjusting the control parameter of the camera device includes:
adjusting the control parameter of the camera device to cause an image parameter of the target object in the real-time photography picture to approach an image parameter of the target object in the sample image.

3. The method of claim 2, wherein the image parameter of the target object in the real-time photography picture includes at least one of a position or a size of the target object in the real-time photography picture.

4. The method of claim 1, wherein the control parameter includes at least one of:
a photography attitude of the camera device or a photography parameter of the camera device.

5. The method of claim 4, wherein adjusting the control parameter of the camera device includes:
comparing the real-time photography picture with the sample image to obtain first position information of the target object in the real-time photography picture and second position information of the target object in the sample image; and
adjusting, according to the first position information and the second position information, the photography attitude of the camera device by controlling a gimbal of the mobile platform to cause a position of the target object in the real-time photography picture to approach a position of the target object in the sample image.

6. The method of claim 5, wherein adjusting the photography attitude of the camera device includes:
determining a position deviation according to the first position information and the second position information; and
adjusting, according to the position deviation, the photography attitude of the camera device by controlling an attitude of the gimbal of the mobile platform.

7. The method of claim 4, wherein adjusting the control parameter of the camera device includes:
comparing the real-time photography picture with the sample image to obtain a size of the target object in the real-time photography picture and a size of the target object in the sample image; and
controlling, according to the size of the target object in the real-time photography picture and the size of the target object in the sample image, the camera device to zoom to cause the size of the target object in the photography picture to approach to the size of the target object in the sample image.

8. The method of claim 7, wherein controlling the camera device to zoom includes:
determining a zoom parameter of the camera device according to the size of the target object in the real-time photography picture and the size of the target object in the sample image; and
controlling the camera device to zoom according to the zoom parameter.

9. The method of claim 7, wherein:
the sample image of the predetermined photography point is stored in the camera device configured to compare the real-time photography picture with the sample image; or
the sample image of the predetermined photography point is stored in a ground end apparatus configured to compare the real-time photography picture with the sample image is the ground end apparatus.

10. The method of claim 1, further comprising:
receiving a user instruction transmitted by a ground end apparatus;
during flight of the mobile platform, in response to receiving a photography point determination instruction transmitted by the ground end apparatus, determining a current position of the mobile platform as the predetermined photography point;
at the predetermined photography point, controlling the camera device of the mobile platform to obtain the sample image with a predetermined configuration;
obtaining position information of the predetermined photography point; and
saving the position information of the predetermined photography point and the sample image of the predetermined photography point.

11. The method of claim 10, wherein controlling the mobile platform to fly according to the user instruction includes:
controlling, according to the user instruction, a real-time height between a lens of the camera device and the target object to be greater than or equal to a predetermined height threshold.

12. The method of claim 10, wherein saving the position information of the predetermined photography point and the sample image of the predetermined photography point includes:
saving the position information of the predetermined photography point at the mobile platform or the ground end apparatus; and
saving the sample image at the mobile platform or the ground end apparatus.

13. The method of claim 12, further comprising, before saving the sample image:
performing downsampling on the sample image; and
saving the sample image after downsampling at the mobile platform or the ground end apparatus.

14. The method of claim 1, wherein the control parameter is a first control parameter, and controlling the mobile platform to fly includes:
controlling the mobile platform to fly according to predetermined flight path information, the predetermined flight path information including position information of the mobile platform at the predetermined photography point and a second control parameter of the mobile platform at the predetermined photography point;.

15. The method of claim 14, wherein the second control parameter includes at least one of:
an attitude of the mobile platform, a photography attitude of the camera device, or a photography parameter of the camera device.

16. The method of claim 15, wherein controlling the mobile platform to fly according to the predetermined flight path information includes:
in response to the mobile platform being at the predetermined photography point, controlling, according to the second control parameter, at least one of a real-time attitude of the mobile platform, a real-time photography attitude of the camera device, or a real-time photography parameter of the camera device.

17. The method of claim 15, wherein obtaining the second control parameter includes:
receiving the user instruction transmitted by the ground end apparatus;
controlling the mobile platform to fly according to the user instruction;
during flight of the mobile platform, in response to receiving a photography point determination instruction transmitted by the ground end apparatus, obtaining at least one of the attitude of the mobile platform, the photography attitude of the camera device, or the photography parameter of the camera device at a current position; and
using at least one of the attitude of the mobile platform, the photography attitude of the camera device, or the photography parameter of the camera device at the current position as the second control parameter of the mobile platform at the predetermined photography point.

18. The method of claim 17, further comprising, after receiving the photography point determination instruction transmitted by the ground end apparatus, and before obtaining the at least one of the attitude of the mobile platform, the photography attitude of the camera device, or the photography parameter of the camera device at the current position:
receiving an adjustment parameter transmitted by the ground end apparatus; and
adjusting, according to the adjustment parameter, the at least one of the attitude of the mobile platform, the photography attitude of the camera device, or the photography parameter of the camera device; and
wherein the at least one of the attitude of the mobile platform, the photography attitude of the camera device, or the photography parameter of the camera device at the current position includes at least one of the attitude of the mobile platform, the photography attitude of the camera device, or the photography parameter of the camera device after parameter adjustment.

19. The method of claim 1, further comprising, after adjusting the control parameter of the camera device to cause the camera device to photograph the target object:
saving an image captured by the camera device at the predetermined photography point.

20. A mobile platform comprising:
a platform body;
a camera device carried by the platform body; and
a controller electrically coupled to the camera device and configured to:
control a mobile platform to move;
in response to the mobile platform being at a predetermined photography point, obtain a pre-stored sample image of the predetermined photography point; and
adjust, according to a real-time photography picture of a camera device of the mobile platform and the sample image, a control parameter of the camera device to cause the camera device to photograph a target object.
